(19) United States
(12) Patent Application Publication
(10) Pub. No.: US 2007/0248510 A1
(43) Pub. Date: Oct. 25, 2007

(54) Dual gas-liquid spargers for catalytic processing units

(76) Inventors: Anne M. Dean, Chantilly, VA (US); John T. Wyatt, Alexandria, VA (US); Rutton D. Patel, Arlington, VA (US); Sid C. Shah, Fairfax, VA (US); Tom J. Schachinger, Washington, DC (US); Charles S. Greenberg, Cherry Hill, NJ (US)

Correspondence Address: ExxonMobil Research & Engineering Company, P.O. Box 900, 1545 Route 22 East, Annandale, NJ, 08801-0900, US

(21) Appl. No.: 11/411,559

(22) Filed: Apr. 25, 2006

(51) Int. Cl. B01J 8/04

(52) U.S. Cl. 422/194; 422/195

(57) ABSTRACT

This invention relates to a quenching device for temperature control in catalytic processes. More particularly, the quenching device includes gas and liquid spargers for interbed temperature control in an interbed mixing zone in a catalytic reactor. The quenching device includes a first injector for injecting a first quenching fluid into an outer mixing zone and a second injector for injecting a second quenching fluid into an inner mixing zone. The quenching fluids include both gaseous and liquid quenching fluids.

### FIELD OF THE INVENTION

This invention relates to a quenching device for temperature control in catalytic processes. More particularly, the quenching device includes gas and liquid spargers for interbed temperature control in the interbed mixing zone of a catalytic reactor. The quenching device includes a first injector for injecting a first quenching fluid into an outer mixing zone and a second injector for injecting a second quenching fluid into an inner mixing zone. The quenching fluids include both gaseous and liquid quenching fluids.

### BACKGROUND OF THE INVENTION

Catalytic hydroprocessing may be used to remove undesirable contaminants from hydrocarbon feedstocks as well as convert certain heavy feedstock fractions into more valuable fractions. Three reactor designs that are available for upgrading heavy hydrocarbon fractions include fixed bed reactor systems, ebullated bed reactor systems and fluidized bed reactor systems.

Fixed bed reactor systems commonly contain multiple catalyst beds separated by interbed zones. Such reactor systems typically involve a downward flow of feed and the co-current flow of gases such as hydrogen, although it is known to have counter-current flow of gases. The reactions involved in each catalyst bed are exothermic thus creating heat which needs to be removed to keep from upsetting reaction conditions for the catalyst in the next bed. Thus unreacted feed, liquid products and gaseous products flow from the upper catalyst bed and enter the interbed zone. The interbed zone usually involves a mixing chamber, and the interbed zone serves at least one of the following functions: (a) introduction of additional reactants and/or quenching materials, (b) mixing of fluid products fluids and quenching materials prior to discharge to the following catalyst bed to improve reaction kinetics in the following bed and (c) control of local “hot spots” within the fluid products to improve temperature uniformity of fluid products entering the downstream bed.

The usual manner of removing excess heat from interbed zones is the use of quenching devices. Most reactor interbed quench systems use gas phase quenching with specially designed internals to enhance mixing of quench gas with the effluent from the upstream catalyst bed. These internals involve piping, support beams and other hardware so that there are constraints upon the interbed volume available.

Inadequate quench zone performance manifests itself in at least two ways. First, the quench zone fails to erase lateral temperature differences at the outlet of the preceding bed or, in the worst cases, amplifies them. An effective quench zone should be able to accept process fluids with 16 to 23° C. lateral temperature differences or higher and homogenize them sufficiently that differences do not exceed about 2° C. at the following bed inlet. A second sign of poor performance is that inlet temperature differences following the quench zone increase as the rate of quench gas is raised. This indicates inadequate mixing of cooler gas with the hot process fluids.

Inadequate quench zone performance limits reactor operation in various ways. When interbed mixing is unable to erase temperature differences, these persist or grow as the process fluids move down the reactor. Hot spots in any bed lead to rapid deactivation of the catalyst in that region which shortens the total reactor cycle length. Product selectivities are typically poorer at higher temperatures; hot regions can cause color, viscosity and other qualities to be off-specification. Also, if the temperature at any point exceeds a certain value (typically 427 to 454° C.), the exothermic reactions may become self-accelerating leading to a runaway which can damage the catalyst, the vessel, or downstream equipment. Cognizant of these hazards, refiners operating with limited internal hardware must sacrifice yield or throughput to avoid these temperature limitations. With present day refinery economics dictating that hydroprocessing units operate at maximum feed rates, optimum quench zone design is a valuable low-cost debottleneck.

One important aspect of the overall mixing efficiency of a quench zone is the ability of the system to mix quench fluids with process fluids. The most critical component of quench mixing efficiency is the methodology though which quench fluid is introduced into the system. There have been various improvements in connection with both physical means and operational considerations for introducing quench into the system.

For example, U.S. Pat. No. 6,180,068 describes an apparatus for mixing vapor and liquid reactants within a column. The apparatus forms a first mixing zone into which a first reactant (e.g. vapor) is homogenized by swirl flow and flows vertically downward. The apparatus further forms a second mixing zone into which a second reactant (e.g., liquid) is homogenized by swirl flow and flows vertically downward. Additional amounts of the first reactant, the second reactant or both may be added into or ahead of the first mixing zone or the second mixing zone as appropriate. The first reactant is directed radially to collide in crossflow with a thin sheet of the second reactant to provide intense mixing of the first and second reactants. Due to separate mixing zones for the two reactants, the mixing conditions for each can be tailored to best mix each reactant while minimizing pressure drop and minimizing the space and volume requirements for this mixing.

There is still a need to improve quench design that would permit the operator to quench using gas alone, liquid alone or some combination of the two while improving gas and liquid distribution and controlling pressure drop.

### SUMMARY OF THE INVENTION

This invention relates to a mixing device for mixing quench gas, quench liquid or both with a two-phase gas-liquid effluent from a reactor or contactor bed in an interbed mixing zone of a reactor, comprising:

(a) a reactor vessel, said reactor having a plurality of catalyst beds,

(b) at least one interbed mixing zone, said interbed mixing zone being a space between adjacent catalyst beds,

(c) at least one collector tray located in said interbed mixing zone for receiving at least one of vapor or liquid from an upper catalyst bed and containing at least one spillway,

(d) at least one conduit for transporting vapor or liquid from the collection tray into the interbed mixing zone, said mixing zone containing an outer mixing zone, an inner mixing zone and a mixing deck,

(e) a first quench injector for introducing a first quench fluid into the outer mixing zone and a second quench injector for injecting a second quench fluid into the inner mixing zone.

Another embodiment of the invention relates to a mixing device for mixing quench gas and quench liquid with a two-phase gas-liquid effluent from a reactor or contactor bed in an interbed mixing zone of a reactor, comprising:

(a) a reactor vessel, said reactor having a plurality of catalyst beds,

(b) at least one interbed mixing zone, said interbed mixing zone being a space between adjacent catalyst beds,

(c) at least one collector tray located in said interbed mixing zone for receiving at least one of vapor or liquid from an upper catalyst bed and containing at least one spillway,

(d) at least one conduit for transporting vapor or liquid from the collection tray into the interbed mixing zone, said mixing zone containing an outer mixing zone, an inner mixing zone and a mixing deck,

(e) a first quench injector for introducing a quench liquid into the outer mixing zone and a second quench injector for injecting a quench gas into the inner mixing zone.

Yet another embodiment of the invention relates to a catalytic reactor comprising

(a) a reactor vessel containing at least one inlet and outlet,

(b) a plurality of catalyst beds within said vessel, said beds being separated by interbed mixing zones,

(c) catalyst support grids for supporting the catalysts beds, said grids allowing passage of gaseous and liquid products from said catalyst beds while preventing passage of catalyst particles,

(d) at least one collector tray located in said interbed mixing zone for receiving at least one of vapor or liquid from an upper catalyst bed and containing at least one spillway,

(e) at least one conduit for transporting vapor or liquid from the collection tray into the interbed mixing zone, said mixing zone containing an outer mixing zone, an inner mixing zone and a mixing deck,

(f) a first quench injector for introducing a quench liquid into the outer mixing zone and a second quench injector for injecting a quench gas into the inner mixing zone.

A further embodiment relates to the use of the catalytic reactor or mixing device for hydroprocessing a hydrocarbon feedstock.

### BRIEF DESCRIPTION OF THE DRAWINGS

FIG. 1 is a sketch of a vertical section of a multi-bed catalytic reactor showing a section view of a portion of the mixing zone apparatus including the dual quench fluid distribution system.

FIG. 2 is a cut away view of a cross section of the interbed mixing zone showing the collection tray and mixing deck.

FIG. 3 is a top cut away view of the dual gas/liquid spargers.

FIG. 4 is an expanded top view of the dual sparger system and an expanded side view of the spargers in relation to the mixing cylinder which is located with the inner sparger.

FIG. 5 is a cut away view showing the quench injection system.

### DETAILED DESCRIPTION OF THE INVENTION

The mixing device will now be described in the context of its use in a reactor having a plurality of catalyst beds. The space between catalyst beds is described as including an interbed mixing zone. At least two quench injectors are located within the mixing zone. The quench injector system is not intended to be restricted to use in a reactor but may be used in other applications as will be appreciated by one skilled in the art.

A catalytic reactor for hydroprocessing of hydrocarbon feedstocks is typically a cylindrical vessel containing an inlet and outlet and includes a plurality of catalyst beds separated by interbed zones. Each interbed zone is bounded by an upper catalyst support grid or internal head support and a lower distribution tray. The internal support head contains a number of perforations to allow passage of liquid and gaseous products while preventing passage of catalyst particles. The products from the catalyst bed are collected in a collector tray and passed to a mixing zone where they are contacted with quenching fluids in the presence of a mixing deck. The quenched products and quench fluids are then conducted through a mixing cylinder to a distributor tray where the quenched products are distributed to a second catalyst bed.

The term hydroprocessing encompasses all processes in which a hydrocarbon feed is reacted with hydrogen at elevated temperature and elevated pressure (hydroprocessing reaction conditions), including hydrogenation, hydrotreating, hydrodesulfurization, hydrodenitrogenation, hydrodemetallization, hydrofinishing, hydrodearomatization, hydroisomerization, hydrodewaxing, hydrocracking, and hydrocracking under mild pressure conditions, which is commonly referred to as mild hydrocracking. Hydroprocessing reactions are concerned with one or more objectives including heteroatom removal (S, N, O and metals), hydrogenation to increase H:C ratio (reducing aromatic and other unsaturates) and cracking C—C bonds (to reduce average molecular weights and boiling points). Hydroprocessing conditions include temperatures of from 150 to 500° C., pressures of from 790 to 27681 kPa (100 to 4000 psig), liquid hourly space velocities of from 0.1 to 20 hr⁻¹, and hydrogen treat gas rates from 17.8 to 1780 m³/m³ (100 to 10000 scf/B).

Hydroprocessing catalysts typically contain metal, i.e., are metal loaded. Hydroprocessing catalysts generally involve a carrier such as a refractory inorganic oxide having deposited thereon a metal, particularly a hydrogenation metal. Typical carrier or supports for catalytic metals include silica, alumina, silica alumina, titania, zirconia, clays, silica-thoria, silica-magnesia and the like. The specific metals, carriers and process conditions are a function of the end use of the hydroprocessing catalyst. Such metals are preferably sulfided since sulfiding normally results in and/or increases catalytic activity. However, not all metal containing hydroprocessing catalysts are sulfided prior to use. The CO treatment may be used on either at least partially sulfided or non-sulfided catalyst, with at least partially sulfided catalysts being preferred.

Metals used in hydroprocessing catalysts are from Groups 3-10 of the Periodic Table based on the IUPAC format having Groups 1-18. Preferred metals are from Groups 6 and 8-10. Especially preferred metals are Mo, W, Ni, Co, and the noble metals. The catalysts may also be doped (promoted) with a variety of dopants such as Y, P Ce, Re, Zr, Hf, U and alkali metals such as Na and K.

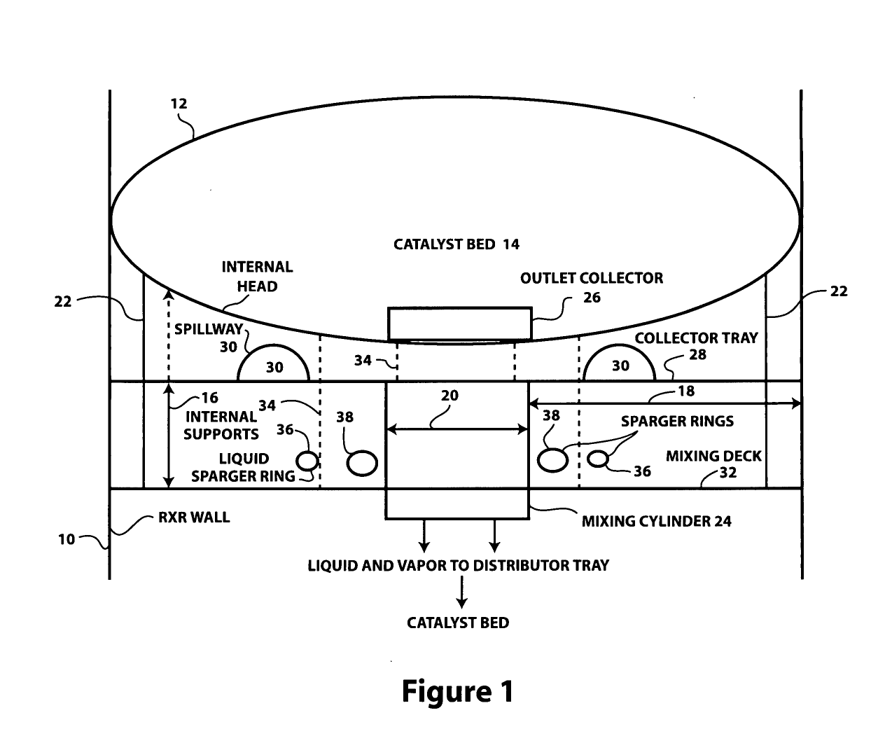

FIG. 1 is a sketch showing a vertical section of a multi-bed catalytic reactor showing a section view of a portion of a typical mixing zone apparatus including the dual quench fluid distribution system of the invention.

This embodiment incorporates two spargers, one for liquid quench and one for gas quench. This is in contrast to the single sparger in a conventional mixing zone. It should be noted that the use of dual spargers is applicable to other mixing zone designs in addition to the embodiment in FIG. 1. As shown in FIG. 1, reactor 10 is a cylindrical vessel having an upper catalyst bed 14 supported on internal head support 12 and a lower catalyst bed (not shown). The interbed mixing zone 16 is that zone defined vertically as between 28 and 32, i.e., the zone between the collection tray 28 and the mixing deck 32. The interbed mixing zone comprises an outer mixing zone 18 and an inner mixing zone 20. The outer mixing zone 18 is located between internal wall support 22 and the wall of mixing cylinder 24. The interior of mixing cylinder 24 forms the inner mixing zone 20. Liquid passing through the catalyst bed is collected in outlet collector 26 and conducted to collector tray 28. Collector tray 28 contains at least two spillways 30. The spillways provide a means to accumulate liquid on collector tray 28 and provide a passage for downflowing liquid and gas from collector tray 28 to interbed mixing zone 16. The distributor tray (not shown) is located below mixing deck 32 and distributes liquid/gas exiting mixing deck 32. Mixing cylinder 24 is surrounded by spargers 36 and 38 which are supported by internal supports 34. Spargers 36 and 38 contain liquid and gas which are used as quench fluids. In a preferred embodiment, gas quenching fluid is contained in sparger 38 and liquid quenching fluid in sparger 36. Gaseous quenching fluid is discharged into inner mixing zone 20 while liquid quenching fluid is discharged into outer mixing zone 18. Quenching fluids and products are further contacted on mixing deck 32 where they accumulate and are conducted to mixing cylinder 24 where they are discharged, together with product mixed with gaseous quenching fluids in mixing zone 20, through the bottom of mixing cylinder 24 to a distributor tray (not shown). The distributor tray contains a plurality of downcomers for distributing liquid/gas uniformly over the lower catalyst bed (not shown).

In FIG. 1, the spargers 36 and 38 are shown in the same plane.

This is preferred but not required and the spargers may be located in separate planes. The use of gas and liquid quenching fluids in spargers 36 and 38 may be reversed with gas quenching fluid in 36 and liquid quenching fluid in 38. The liquid quench fluid is preferably product from reactor 10 but may also be feed to reactor 10 or any other inert liquid hydrocarbon. Gas quenching fluid is preferably treat gas which is predominantly hydrogen but may be pure hydrogen or any other inert gas such as nitrogen or gaseous hydrocarbons recovered from the reactor. These gaseous hydrocarbons may include C₁ to C₄ hydrocarbon or mixtures thereof. The mixing zone apparatus in FIG. 1 may be located between any successive beds in the reactor. The mixing zone apparatus according to the invention may also be used in combination with conventional gas quench known in the art. If a combination of conventional gas quench and the dual gas/liquid quench according to the invention is desired, it is preferred to use conventional gas quench in upper interbed zones and dual gas/liquid quench according to the invention in lower interbed zones.

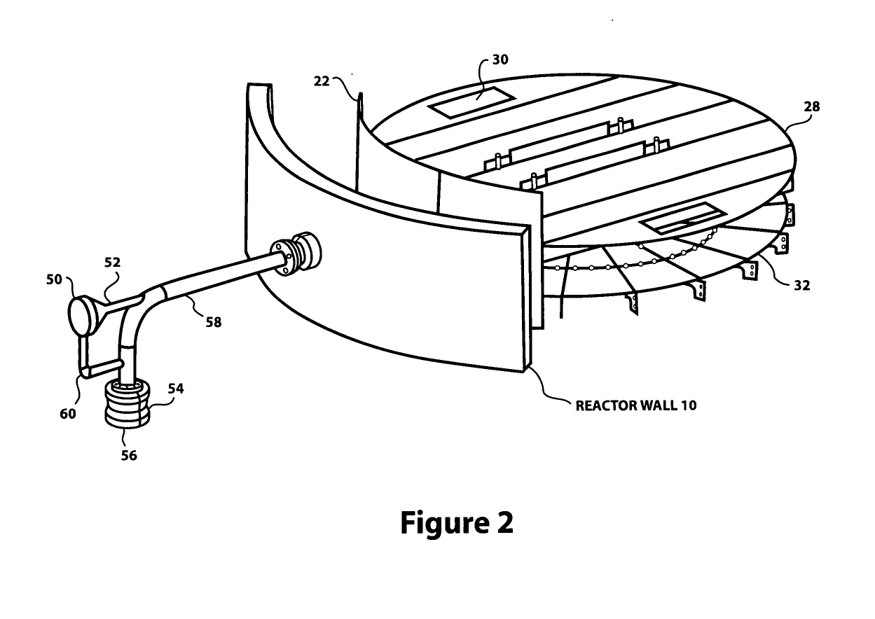

FIG. 2 is a cut away view of a cross section of the interbed mixing zone showing the collection tray and mixing deck. In FIG. 2, inner wall support 22 inside reactor 10 surrounds collection tray 28 and mixing deck 32. Spillway 30 is located in collection tray 28. Filtered liquid is added to the quench injection system through line 52. Liquid quench is filtered to minimize nozzle plugging. Gaseous quench is added at 56 through check valve 54 and added to the quench injection system through line 58. Line 60 is a gas to liquid line jumper and is used to flush out liquid from line 52.

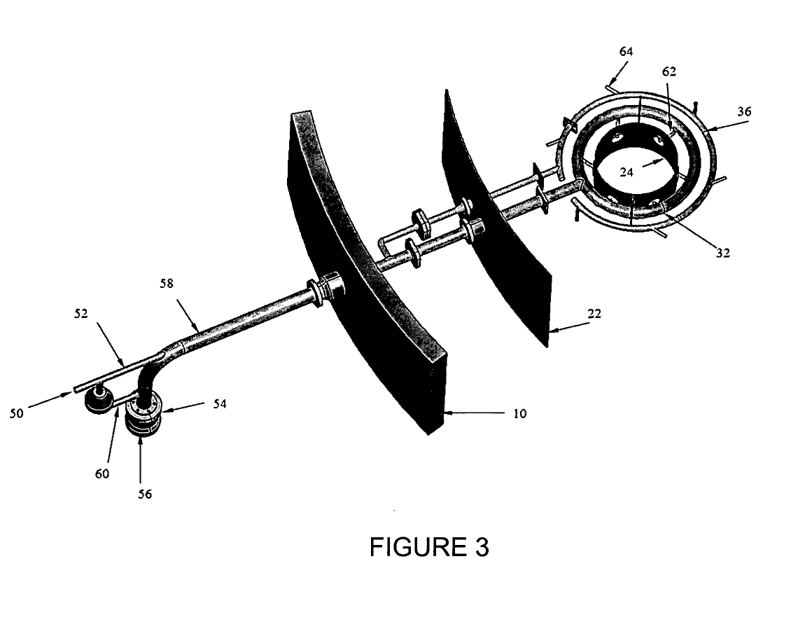

FIG. 3 is a top cut away view of the dual gas/liquid spargers of the invention. In FIG. 3, the gas/liquid inlet system contains a dual conduit system containing an inner conduit 52 for conducting liquid quench fluid and an outer conduit 58 for conducting gas quench fluid. The dual conduit system in particularly suited for retrofit applications since it avoids installing new nozzles in the thick-walled shell of the reactor. For a grass roots design, two separate nozzles for liquid and gas respectively can readily be provided. For such a grass roots design, both nozzles for gas and liquid could be at the reactor wall, preferably in the same plane, thus obviating the need for a dual conduit system. These dual conduits pass through reactor wall 10 and internal wall support 22. The gas quench fluid conduit is connected to sparger 38 while the liquid quench fluid conduit is connected to sparger 36. Spargers 36 and 38 surround mixing cylinder 24. Each of spargers 36 and 38 contain quench nozzles 62 and 64 that are radially directed to produce a swirling motion in the liquid and gas products from the collector tray.

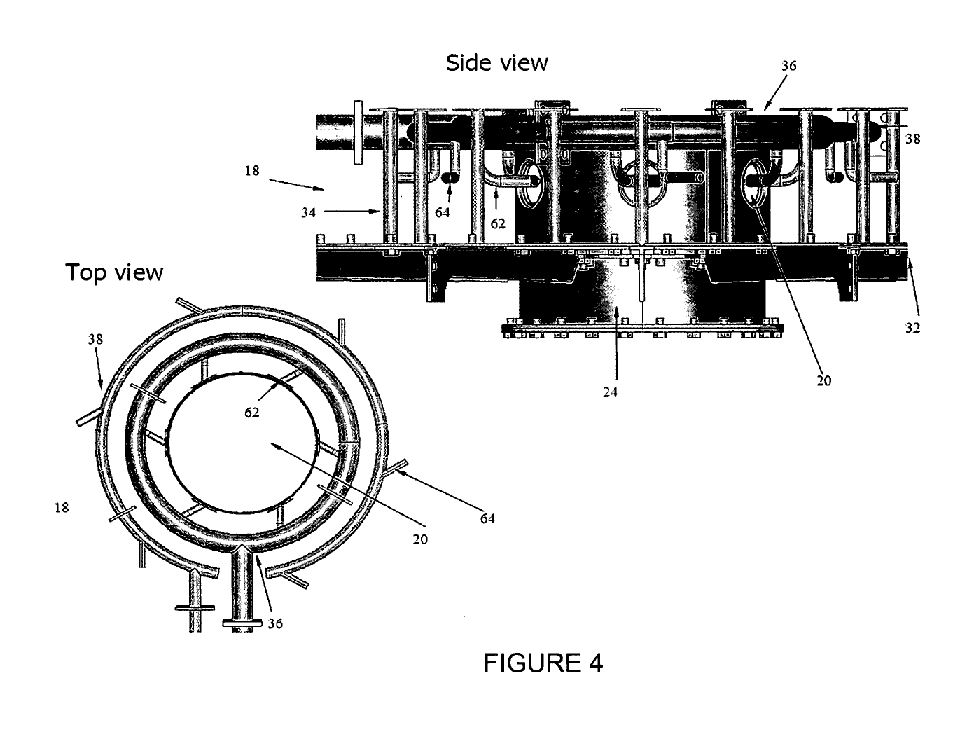

FIG. 4 is an expanded top view of the dual sparger system of the invention and an expanded side view of the spargers in relation to the mixing cylinder which is located within the inner sparger. Inner sparger 36 and outer sparger 38 contain quench nozzles 62 and 64. Quench nozzles 62 discharge into inner mixing zone 20 while quench nozzles 64 discharge into outer mixing zone 18. The angle between the quench nozzles and the spargers to which they are attached are less than 90°, preferably between 35 and 55°. The angles formed by nozzles 62 and 64 may be the same or different but they should produce the same direction of rotation in the horizontal plane which contributes to effective mixing. The inward pointing gas nozzles have circular openings and produce a conical expanding jet that entrains surrounding fluid and mixes the gas with the surrounding fluid. In addition, these jets produce the swirling flow in the horizontal plane which further increases mixing. The outward pointing liquid nozzles have a rectangular cross-section of high aspect ratio producing a flat fan-shaped spray pattern of liquid drops in the horizontal plane which provides a large surface area for interphase heat and mass transfer between the spray and the surrounding fluid which is moving across the flat fan spray. This produces excellent mixing and rapid heat transfer and cooling. Both types are nozzles are commercially available from nozzle manufacturers.

The side view shows the spargers in relation to mixing cylinder 24. Mixing cylinder 24 is connected to mixing deck 32. Spargers 36 and 38 are shown in the same plane with nozzles 62 from inner sparger 36 being directed into inner mixing zone 20 and nozzles 64 from outer sparger 38 being directed into outer mixing zone 18. Gases and liquids from collector tray 28 enter zones 18 and 20 through spillways in collector tray 28.

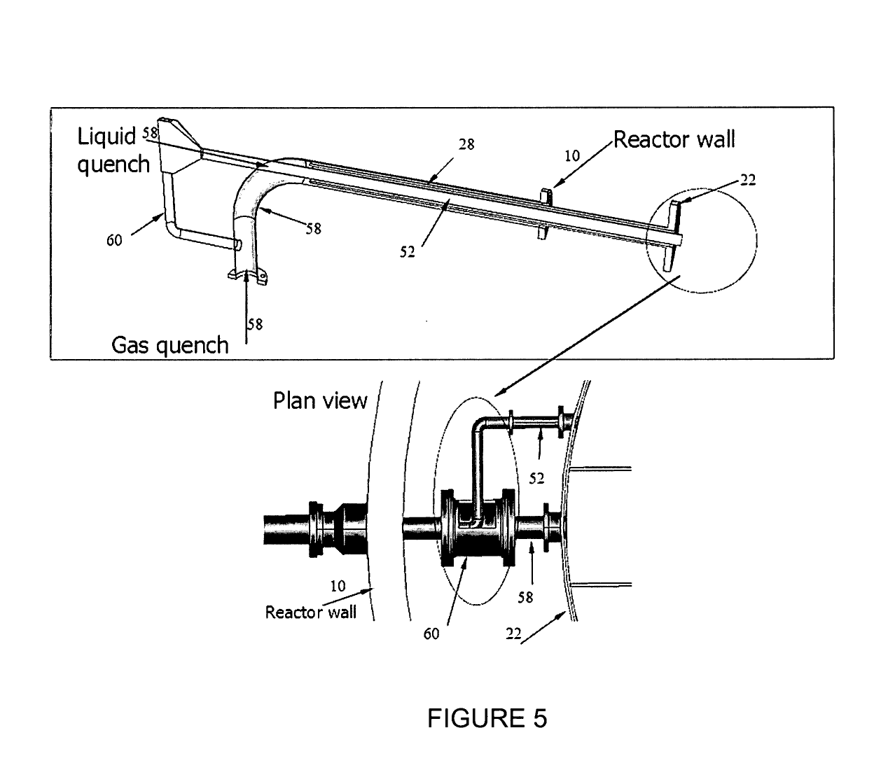

FIG. 5 is a cut away view showing the quench injection system. The expanded view illustrates the double piping system used to inject quench fluids which as noted above is advantageous for retrofit applications. Liquid quench is injected through inner conduit 52. Gaseous quench is injected through inlet 56 into outer conduit 58. Both inner and outer conduits pass through reactor wall 10 and through internal support wall 22. Gas purge line 60 provides a means to flush inner conduit 52 using gas from line 58. This removes liquid from 52 that otherwise might be susceptible to coke formation during liquid shutoff periods. The plan view provides further details relating to injection through internal wall 22. After passing through reactor wall 10, the double conduit arrangement is split at splitter 66. The inner conduit 52 passes through internal wall 22 and on to sparger 36 (not shown). The outer conduit 58 passes through internal wall 22 and on to sparger 38 (not shown).

The dual sparger quench injection system according to the invention provides advantages over the conventional single sparger system. These include: (1) easy to retrofit, (2) minimizes the number of nozzles required to introduce quench flow, (3) provides increased flexibility for quenching using both gas and liquid quench or either alone, and (4) when using both gas and liquid quench, avoids poor flow distributions that can occur in a single sparger two phase system caused by flow regime changes as quench rates are varied.

1. A mixing device for mixing quench gas, quench liquid or both with a two-phase gas-liquid effluent from a reactor or contactor bed in an interbed mixing zone of a reactor, comprising:
(a) a reactor vessel, said reactor having a plurality of catalyst beds,
(b) at least one interbed mixing zone, said interbed mixing zone being a space between adjacent catalyst beds,
(c) at least one collector tray located in said interbed mixing zone for receiving at least one of vapor or liquid from an upper catalyst bed and containing at least one spillway,
(d) at least one conduit for transporting vapor or liquid from the collector tray into the interbed mixing zone, said mixing zone containing an outer mixing zone, an inner mixing zone and a mixing deck,
(e) a first quench injector for introducing a first quench fluid into the outer mixing zone and a second quench injector for injecting a second quench fluid into the inner mixing zone.

2. The device of claim 1 wherein the interbed mixing zone is bounded by the collector tray and the mixing deck.

3. The device of claim 1 wherein the first quench fluid is a liquid.

4. The device of claim 1 wherein the second quench fluid is a gas.

5. The device of claim 3 wherein the liquid quench fluid is at least one of product from the upper catalyst bed, feed to the reactor vessel or other inert liquid hydrocarbon.

6. The device of claim 4 wherein the gas quench fluid is at least one of treat gas, hydrogen, gaseous product from the upper catalyst bed, nitrogen or other inert gas.7. The device of claim 1 wherein the upper catalyst bed is supported on a catalyst grid.

7. The device of claim 1 wherein the first and second quench fluids are injected using a dual sparger system.

8. The device of claim 1 wherein the inner mixing zone comprises the interior of a mixing cylinder.

9. The device of claim 8 wherein the outer mixing zone is bounded by the reactor vessel having a reactor wall and the mixing cylinder.

10. The device of claim 1 wherein the first and second quench injectors comprise a plurality of nozzles.

11. The device of claim 10 wherein the plurality of nozzles are attached to dual spargers.

12. The device of claim 11 wherein the angle formed between the dual sparger and the nozzles is less than 90°.

13. The device of claim 12 wherein the angle is between 35 and 55°.

14. The device of claim 10 wherein the first quench injector nozzles are directed into the outer mixing zone.

15. The device of claim 10 wherein the second quench injector nozzles are directed into the inner mixing zone.

16. The device of claim 14 wherein the first quench injector nozzles form a fan shaped spray pattern.

17. The device of claim 15 wherein the second quench injector nozzles form a conical spray pattern.

18. The device of claim 1 wherein the first and second quench fluids are conducted to the first and second quench injectors by a dual conduit system passing through the reactor vessel wall.

19. The device of claim 18 wherein the dual conduit system comprises an outer conduit and an inner conduit.

20. The device of claim 19 wherein liquid quench is added through the inner conduit and gas quench is added through the outer conduit.

21. A catalytic reactor comprising:
(a) a reactor vessel containing at least one inlet and outlet,
(b) a plurality of catalyst beds within said vessel, said beds being separated by interbed mixing zones,
(c) catalyst support grids for supporting the catalysts beds, said grids allowing passage of gaseous and liquid products from said catalyst beds while preventing passage of catalyst particles,
(d) at least one collector tray located in said interbed mixing zone for receiving at least one of vapor or liquid from an upper catalyst bed and containing at least one spillway,
(e) at least one conduit for transporting vapor or liquid from the collection tray into the interbed mixing zone, said mixing zone containing an outer mixing zone, an inner mixing zone and a mixing deck,
(f) a first quench injector for introducing a quench liquid into the outer mixing zone and a second quench injector for injecting a quench gas into the inner mixing zone.

22. The use of the device of claim 1 for hydroprocessing hydrocarbons.

23. The use of the reactor of claim 21 for hydroprocessing hydrocarbons.
